(19) United States
(12) Patent Application Publication
(10) Pub. No.: US 2011/0058217 A1
(43) Pub. Date: Mar. 10, 2011

(54) ELECTRONIC DEVICE

(75) Inventor: Takeshi Saito, Shiohiri-shi (JP)

(73) Assignee: SEIKO EPSON CORPORATION, Shinjuku-ku (JP)

(21) Appl. No.: 12/877,929

(22) Filed: Sep. 8, 2010

(30) Foreign Application Priority Data
Sep. 9, 2009 (JP) 2009-208229

(51) Int. Cl. G06F 15/00

(52) U.S. Cl. 358/1.15; 358/1.16

(57) ABSTRACT

An electronic device includes a plurality of RAMs which are capable of executing self-refresh, a first power supply unit which supplies power to some of RAMs among the above plurality of RAMs, a second power supply unit which supplies power to RAMs other than the some of RAMs among the above plurality of RAMs with supply paths different from that of the first power supply unit, and a controller which controls power supply based on change of operation modes. In the electronic device, when the controller receives a transition instruction to a power saving mode, the controller records programs stored in the plurality of RAMs in the some of RAMs, makes at least the some of RAMs be in a self-refresh state, and stops power supply to the RAMs other than the some of RAMs by the second power supply unit.

### BACKGROUND

1. Technical Field

The present invention relates to an electronic device.

2. Related Art

An image formation system in which a RAM performs self-refresh so as to hold a state at the time of transition from a stand-by state to an energy saving mode has been known (see, JP-A-2004-5029).

Further, an image processing apparatus including a standard RAM and an option RAM in which electricity is supplied to the standard RAM and electricity is not applied to the option RAM in a power saving mode has been known (see, JP-A-2004-112718).

In the field of a printer, a complex machine, or the like, further reduction in power consumption in a sleep mode (power saving mode) is desired. Furthermore, a processing for returning from the power saving mode state to a normal operation state is also desired to be made faster together with such reduction in power consumption.

The reduction in power consumption realized by simply self-refreshing a RAM at the time of transition from the stand-by state to the energy saving mode as described in JP-A-2004-5029 has been less than sufficient. Further, an apparatus such as a printer includes a plurality of RAMs in order to execute programs or the like in some case. In addition, program data is stored in each of the RAMs in the normal operation in some case. In such apparatus including a plurality of RAMs, it has been desired that reduction in power consumption be reliably realized while data stored in each of the RAMs is appropriately held at the time of transition to the power saving mode. However, it has been difficult to achieve such compatibility in JP-A-2004-112718 described above.

### SUMMARY

An advantage of some aspects of the invention is to provide an electronic device which solves at least one of above described problems and which reliably realizes reduction in power consumption while appropriately holding necessary data in a power saving mode and which also contributes to make a processing of returning from a power saving mode state to a normal operation state be faster.

An electronic device according to an aspect of the invention includes a plurality of RAMs which are capable of executing self-refresh, a first power supply unit which supplies power to some of RAMs among the above plurality of RAMs, a second power supply unit which supplies power to RAMs other than the some of RAMs among the above plurality of RAMs with supply paths different from that of the first power supply unit, and a controller which controls power supply based on change of operation modes. In the electronic device, when the controller receives a transition instruction to a power saving mode, the controller records programs stored in the plurality of RAMs in the some of RAMs, makes at least the some of RAMs be in a self-refresh state, and stops power supply to the RAMs other than the some of RAMs by the second power supply unit, and when the controller receives a return instruction from the power saving mode to a normal operation mode, the controller restarts power supply to the RAMs other than the some of RAMs by the second power supply unit, cancels the self-refresh state of the some of RAMs, and writes back the programs recorded in the some of RAMs into each of the plurality of RAMs.

According to the aspect of the invention, when the electronic device becomes in the power saving mode, programs stored in each RAM are collectively recorded in some of RAMs and the some of RAMs are made to be in the self-refresh state. Further, power supply to the RAMs other than the some of RAMs is stopped. In other words, power supply to only RAM(s) used for holding programs in the power saving mode is not stopped and power supply to the RAMs other than the some of RAMs is stopped. This makes it possible to appropriately hold programs which have been stored in each RAM and reliably realize reduction in power consumption. In addition, since the programs are held in the RAM(s) in the power saving mode, when the electronic device returns from the power saving mode to the normal operation mode, the programs can be executed instantaneously.

It is preferable that the programs be programs which are necessary for responding to at least one of a print request from the outside, a request to receive or transmit a facsimile, and a request to control a user interface. That is to say, the above programs to be executed instantaneously when the electronic device is returned from the power saving mode to the normal operation mode are held in some of RAMs in the power saving mode. Therefore, in the electronic device, a response speed to a print request from the outside, a request to receive or transmit a facsimile, a request to control a user interface, or the like is made faster.

It is preferable that when the controller receives the transition instruction to the power saving mode, the controller record programs stored in the plurality of RAMs in the some of RAMs and make all of the plurality of RAMs in a self-refresh state. With the configuration, since the controller does not have to specify target RAM(s) to be self-refreshed, a processing can be simplified.

The electronic device according to the aspect of the invention may be a printer or a complex machine including at least a printing function, a scanning function and a facsimile function, for example.

Further, an electronic device according to another aspect of the invention may include a plurality of RAMs which are capable of executing self-refresh, a plurality of power supply units which correspond to the plurality of RAMs in a one-to-one correspondence and supply power to the corresponding RAMs with supply paths which are different from each other, and a controller which controls power supply based on change of operation modes. In the electronic device, when the controller receives a transition instruction to a power saving mode, the controller specifies one or more RAMs which are necessary for recording the programs from the plurality of RAMs based on data amount of the programs stored in the plurality of RAMs, records the programs in the specified RAM(s), makes at least the specified RAM(s) be in a self-refresh state, and stops power supply to the RAM(s) other than the specified RAM(s) by each of the power supply units, and when the controller receives a return instruction from the power saving mode to a normal operation mode, the controller restarts power supply to the RAM(s) other than the specified RAM(s), cancels the self-refresh state of the specified RAM(s), and writes back the programs recorded in the specified RAM(s) into each of the plurality of RAMs. With this configuration, power supply to each RAM can be individually controlled. In addition, RAM(s) to which power supply is not stopped (RAM(s) holding programs with self-refresh) and RAM(s) to which power supply is stopped can be separated based on the data amount of the programs to be held at this time. Further, power supply to only RAM(s) used for holding data in the power saving mode is not stopped and power supply to RAM(s) other than the above RAM(s) is stopped. This makes it possible to appropriately hold program data which have been stored in each RAM and reliably realize reduction in power consumption. In addition, since the programs are held in the RAM(s) in the power saving mode, when the electronic device returns from the power saving mode to the normal operation mode, the programs can be executed instantaneously.

An electronic device according to still another aspect of the invention may include a plurality of RAMs which are capable of executing self-refresh, a first power supply unit which supplies power to some of RAMs in which a predetermined program is stored among the above plurality of RAMs, a second power supply unit which supplies power to RAMs other than the some of RAMs among the above plurality of RAMs with supply paths different from that of the first power supply unit, and a controller which controls power supply based on change of operation modes. In the electronic device, when the controller receives a transition instruction to a power saving mode, the controller makes at least the some of RAMs be in a self-refresh state, and stops power supply to the RAMs other than the some of RAMs by the second power supply unit, and when the controller receives a return instruction from the power saving mode to a normal operation mode, the controller restarts power supply to the RAMs other than the some of RAMs by the second power supply unit, and cancels the self-refresh state of the some of RAMs. With this configuration, power supply to only the some of RAMs used for holding programs in the power saving mode is not stopped and power supply to RAMs other than the some of RAMs is stopped. This makes it possible to appropriately hold programs which have been stored in the some of RAMs and reliably realize reduction in power consumption. In addition, since the programs are held in the RAM(s) in the power saving mode, when the electronic device returns from the power saving mode to the normal operation mode, the programs can be executed instantaneously.

Technical ideas according to the aspects of the invention can be realized by some aspects other than the electronic device. For example, an invention of a method including processing steps executed by each component of the electronic device, or an invention of a computer readable program which makes a computer execute functions executed by each component of the electronic device may be conceivable.

### BRIEF DESCRIPTION OF THE DRAWINGS

The invention will be described with reference to the accompanying drawings, wherein like numbers reference like elements.

FIG. 1 is a block diagram illustrating a schematic configuration of an example of an electronic device and the like.

FIG. 2 is a block diagram illustrating a schematic configuration of another example of an electronic device and the like.

FIG. 3 is a diagram illustrating an example of a circuit for controlling power supply to a plurality of RAMs.

FIG. 4 is a flowchart illustrating a transition processing to a power saving mode.

FIG. 5 is a flowchart illustrating a return processing to a normal operation mode.

FIG. 6 is a diagram illustrating another example of a circuit for controlling power supply to a plurality of RAMs.

FIG. 7 is a flowchart illustrating a transition processing to a power saving mode according to a modification.

FIG. 8 is a flowchart illustrating a return processing to a normal operation mode according to the modification.

### DESCRIPTION OF EXEMPLARY EMBODIMENTS

Hereinafter, an embodiment of the invention will be described with reference to drawings.

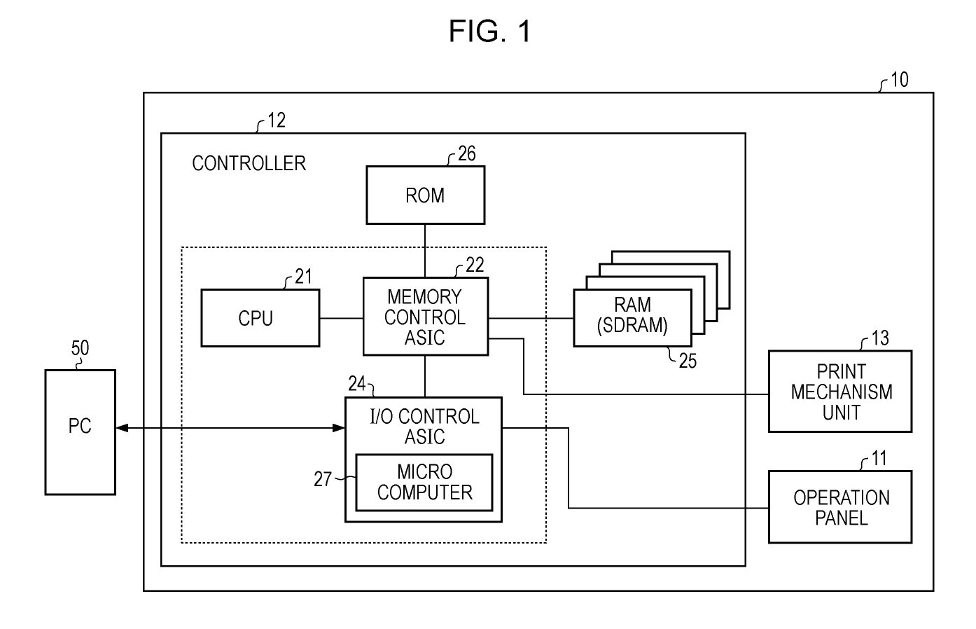

FIG. 1 is a block diagram illustrating a schematic configuration of an electronic device 10 according to the embodiment. In FIG. 1, the electronic device 10 is a printer. The printer is a page printer including an operation panel 11, a controller 12, a print mechanism unit 13 and the like, for example. The operation panel 11 is a unit for receiving various types of instructions from a user and displaying a state of the electronic device 10 to a user. For example, the operation panel 11 is composed of a liquid crystal display, an LED, a push button switch and the like and is connected to an I/O control ASIC 24. The print mechanism unit 13 is a unit which prints onto a sheet (so-called print engine) based on print data transmitted from a personal computer (PC) 50 to the controller 12. The personal computer (PC) 50 serves as a host device for the printer. A printer driver for controlling the driving of the printer is installed on the PC 50.

The controller 12 is a unit for controlling each part of the electronic device 10. The controller 12 includes a CPU 21, a memory control ASIC 22, the I/O control ASIC 24, a plurality of RAMs (for example, SDRAM) 25 (25a, 25b, 25c, 25d . . . ), a ROM 26 and the like. The I/O control ASIC 24 realizes a USB interface, an interface to an external network, and the like. In the embodiment, a regulator control micro computer 27 (hereinafter, simply referred to as micro computer 27) is mounted on the I/O control ASIC 24.

The micro computer 27 is a controller for a transition processing from a normal operation mode to a power saving mode and a return processing from the power saving mode to the normal operation mode as described below. It is to be noted that the micro computer 27 may be mounted on the memory control ASIC 22 or the like, for example.

The memory control ASIC 22 and the I/O control ASIC 24 are ASICs (ASICs developed for the electronic device 10) for controlling data transfer between various types of devices (CPU 21, RAM 25, ROM 26, operation panel 11, print mechanism unit 13, device connected through each interface), and executing an image processing or the like. For example, the CPU 21, the memory control ASIC 22 and the I/O control ASIC 24 can be constituted by forming these components on one chip (see, a chain line in FIG. 1).

When a user operates the PC 50 for printing with the printer (electronic device 10), print data generated by a printer driver of the PC 50 (print data including print data which represents an image to be printed by a predetermined page-description language, for example) is input to the controller 12 from the PC 50 through an external network together with a print request. Such print data is once stored in the RAM 25 through the I/O control ASIC 24 and the memory control ASIC 22. Thereafter, the print data is subjected to predetermined image processings (for example, a language interpretation processing, a color conversion processing, a resolution conversion processing, a compression and expansion processing, a binarization processing or the like) by the controller 12. As a result, image data in a BMP format is generated and the generated image data is transmitted to the print mechanism unit 13 so that the print mechanism unit 13 executes printing based on the image data.

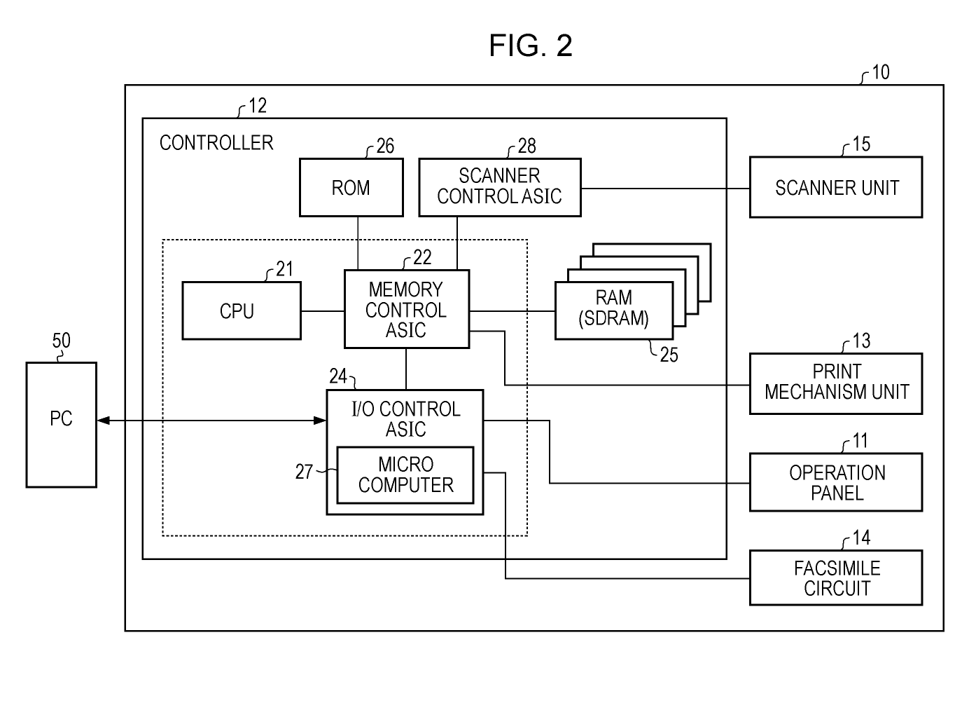

FIG. 2 is a block diagram illustrating a schematic configuration of an example of the electronic device 10 according to the embodiment. The example of the electronic device 10 in FIG. 2 is different from that in FIG. 1. As shown in FIG. 2, the electronic device 10 is a so-called complex machine. In FIG. 2, the electronic device 10 further includes a facsimile circuit 14, a scanner unit (image reading unit) 15 and a scanner control ASIC 28 in addition to the components in FIG. 1. In FIG. 2, the same reference numerals designate the same components as those in FIG. 1.

The complex machine includes a scanning function and a facsimile function, or the like in addition to the printing function.

The facsimile circuit 14 is connected to a predetermined interface of the I/O control ASIC 24. The facsimile circuit 14 includes a modem connecting to a predetermined facsimile communication line. Facsimile data transmitted from the outside through the communication line is converted by the modem so that the facsimile circuit receives the image data. The facsimile circuit 14 outputs the image data to the controller 12 through the I/O control ASIC 24. The facsimile circuit 14 converts image data provided from the scanner unit 15 through the I/O control ASIC 24 by the modem so as to transmit the facsimile data after conversion to the outside through the communication line.

The scanner unit 15 is controlled by the scanner control ASIC 28 so as to read a manuscript set on a manuscript table of the complex machine with an optical sensor and generate image data of the manuscript. The image data generated by the scanner unit 15 is stored in a predetermined memory (RAMs 25, an HDD (not shown) or the like) through the scanner control ASIC 28 and the memory control ASIC 22. Alternatively, the image data is transmitted to the print mechanism unit 13 for printing, or is transmitted to an external facsimile machine by the facsimile circuit 14.

The print mechanism unit 13 can perform printing onto a sheet based on the image data received by the facsimile circuit 14 or the image data generated by the scanner unit 15 in addition to printing based on print data input from the PC 50. In this case, it is needless to say that the controller 12 performs predetermined processings (for example, a color conversion processing, a resolution conversion processing, a compression and expansion processing, a binarization processing or the like) on each image data as needed so as to generate image data in a bitmap format. Note that the electronic device 10 proposed by the invention is not limited to the printer and the complex machine as described above and is applicable to various types of electronic devices such as a scanner.

Next, configurations and processing contents relating to a transition processing from the normal operation mode to the power saving mode and a return processing from the power saving mode to the normal operation mode are described. The power saving mode indicates a state where power supply to some of the components of the electronic device 10 is stopped so as to reduce power consumption. The normal operation mode indicates a state where all components in the electronic device 10 can be basically driven without components in such state where power supply is stopped.

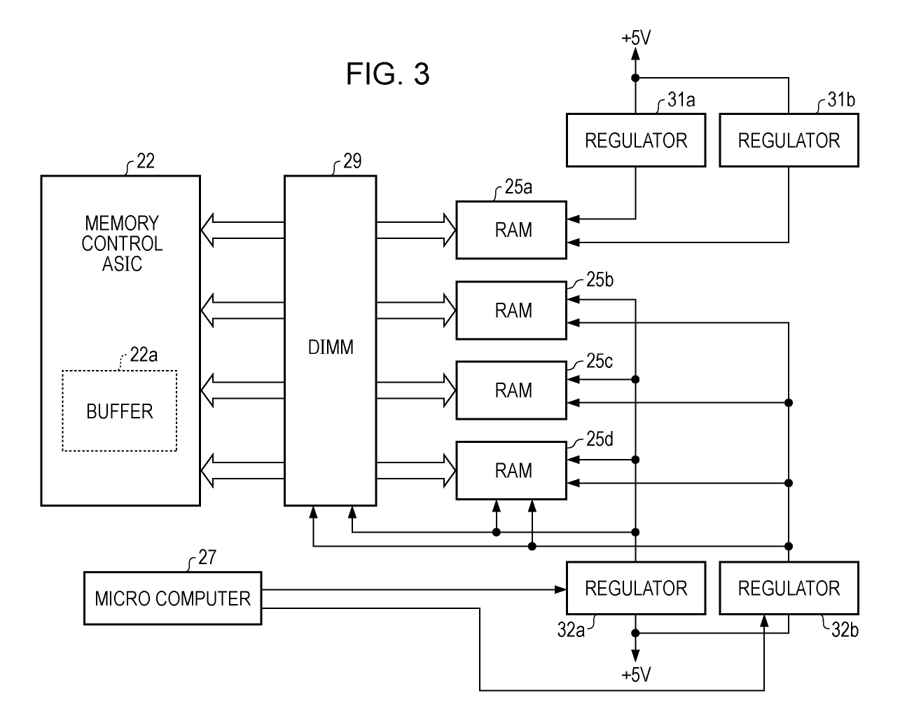

FIG. 3 is a block diagram illustrating a circuit including the memory control ASIC 22, a plurality of RAMs 25a, 25b, 25c, 25d, the micro computer 27, and the like. In FIG. 3, the memory control ASIC 22 is connected to four RAMs 25a, 25b, 25c, 25d through a DIMM (Dual Inline Memory Module) 29 as a memory module. Each of the RAMs 25a, 25b, 25c, 25d can execute self-refresh. As shown in FIG. 3, the RAMs 25a, 25b, 25c, 25d are divided into two groups depending on different power supply systems. To be more specific, the RAM 25a belongs to one group and inputs a voltage output from the regulators 31a, 31b.

Each of the regulators 31a, 31b is a circuit for keeping an output voltage at a predetermined level and inputs a power supply voltage of 5V. The regulator 31a outputs a voltage of 1.8 V as a power supply voltage of the RAM 25a. The regulator 31b outputs a voltage of 0.9 V as a reference voltage.

The RAMs 25b, 25c, 25d which belong to the other group input voltages output from the regulators 32a, 32b. Each of the regulators 32a, 32b also inputs a power supply voltage of 5 V. The regulator 32a outputs a voltage of 1.8 V as a power supply voltage of the RAMs 25b, 25c, 25d. The regulator 32b outputs a voltage of 0.9 V as a reference voltage. Accordingly, the RAM 25a corresponds to some of RAMs according to the invention and the RAMs 25b, 25c, 25d correspond to the RAMs other than the some of RAMs according to the invention. Further, the regulators 31a, 31b correspond to a first power supply unit and the regulator 32a, 32b correspond to a second power supply unit.

The regulator 32a also outputs the voltage of 1.8 V as the power supply voltage to the memory control ASIC 22 and the DIMM 29. Further, the regulator 32b also outputs the voltage of 0.9 V as the reference voltage to the memory control ASIC 22 and the DIMM 29. Moreover, the regulators 32a, 32b are connected to the micro computer 27 and turn ON/OFF the supply voltage (power supply voltage and reference voltage) supply to the memory control ASIC 22 and the DIMM 29 based on the control of the micro computer 27.

In the electronic device 10 having such configuration, the micro computer 27 executes the transition processing from the normal operation mode to the power saving mode and the return processing from the power saving mode to the normal operation mode. The micro computer 27 corresponds to an example of a controller in the scope of the invention.

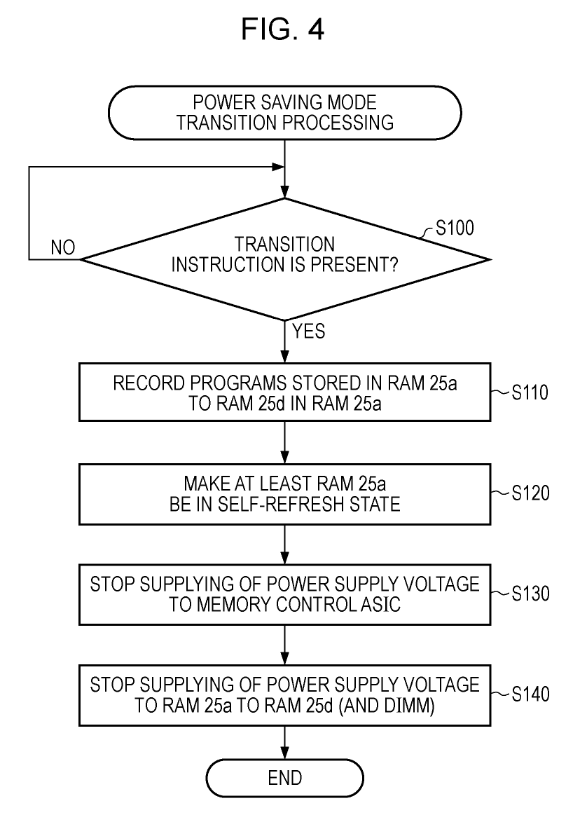

FIG. 4 is a flowchart illustrating the transition processing from the normal operation mode to the power saving mode. The transition processing is executed when the electronic device 10 is in the normal operation mode.

The micro computer 27 judges whether a transition instruction to the power saving mode is received in step S100. If the micro computer 27 judges that the transition instruction is received, the process proceeds to step S110. The transition instruction to the power saving mode is an instruction output from the I/O control ASIC 24 to the micro computer 27, for example. For example, if there is no input (input to the operation panel 11, input of print request through an interface corresponding to an external network or the like, reception of a facsimile signal through the facsimile circuit 14) from the outside for a specified period of time or more, the I/O control ASIC 24 outputs the above transition instruction.

In step S110, the micro computer 27 copies programs which are being stored in the RAMs 25a, 25b, 25c, 25d at this time and records the programs in the RAM 25a as the above some of RAMs. In the embodiment, the programs stored in the ROM 26 are copied so as to be divided and stored in each of the RAMs 25a, 25b, 25c, 25d in the normal operation mode. Further, processings based on the programs stored in these RAMs 25a, 25b, 25c, 25d are executed while the DIMM 29 is mainly set to be a working area in the normal operation mode. Accordingly, in the step S110, each program stored in each of the RAMs 25a, 25b, 25c, 25d in such a manner are collectively recorded in the RAM 25a. The program mentioned herein indicates a program for executing print control in response to the print request through an external network, a program for executing control of the reception and transmission in response to the reception request or the transmission request of the facsimile, a program for executing display control of a user interface in response to an operation (request) onto an user interface (operation panel 11 or the like) or the like in the electronic device 10, for example. Alternatively, the program mentioned herein indicates a part of these programs.

In step S120, the micro computer 27 makes at least the RAM 25a which is not connected to the regulators 32a, 32b among the plurality of RAMs 25a, 25b, 25c, 25d be in a self-refresh state. As a result, recorded contents at that time (programs which have been stored in the RAMs 25a, 25b, 25c, 25d before the step S110) are held in the RAM 25a. Since the micro computer 27 makes at least the RAM 25a which is not connected to the regulators 32a, 32b be in a self-refresh state, the micro computer 27 may make all the plurality of RAMs 25a, 25b, 25c, 25d be in a self-refresh state. If all the plurality of RAMs 25a, 25b, 25c, 25d are made to be in a self-refresh state, a RAM to be self-refreshed is not required to be specified from the plurality of RAMs so that the processing in the step S120 is simplified.

In step S130, the micro computer 27 controls the regulators 32a, 32b so as to stop voltage supply from the regulators 32a, 32b to the memory control ASIC 22. With such control, the memory control ASIC 22 is made to be in an undriven state. However, note that the micro computer 27 may be mounted on the memory control ASIC 22 as described above.

Accordingly, when the micro computer 27 is mounted on the memory control ASIC 22, the micro computer 27 stops voltage supply from the regulators 32a, 32b not to the entire memory control ASIC 22 but to a buffer 22a in the memory control ASIC 22.

In step S140, the micro computer 27 stops voltage supply by the regulators 32a, 32b. As a result, voltage supply to each of the RAMs 25b, 25c, 25d and the DIMM 29 is stopped so as to make the RAMs 25b, 25c, 25d and the DIMM 29 be in an undriven state. As a result, data in the RAMs 25b, 25c, 25d are erased regardless of whether self-refresh has been executed in the above step S120. On the other hand, even when the transition processing to the power saving mode is executed in such a manner, voltage supply to the RAM 25a by the regulators 31a, 31b continues. Therefore, the RAM 25a is kept to be in the self-refresh state. Note that when the electronic device 10 is made to be in the power saving mode, power supply to each of the CPU 21, the ROM 26, the print mechanism unit 13, the scanner unit 15, the scanner control ASIC 28, a part of the I/O control ASIC 24 is also stopped.

A part of the I/O control ASIC 24 mentioned here indicates the part of the I/O control ASIC 24 other than components necessary for communication between the micro computer 27 and each interface with the operation panel 11, an external network, the facsimile circuit 14, or USB device. Thus, the transition to the power saving mode is completed.

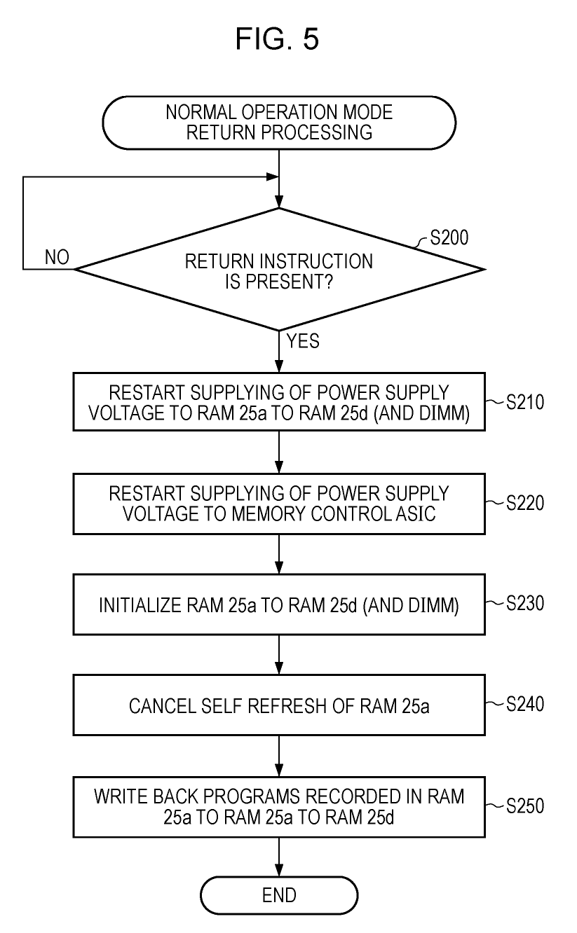

FIG. 5 is a flowchart illustrating the return processing from the power saving mode to the normal operation mode. The processing is executed when the electronic device 10 is in the power saving mode.

The micro computer 27 judges whether a return instruction to the normal operation mode is received in step S200. When the micro computer 27 judges that the return instruction is received, the process proceeds to step S210. The return instruction to the normal operation mode is an instruction output to the micro computer 27 through each interface of the I/O control ASIC 24. For example, when there is an input from the outside (input to the operation panel 11, input of print request through the interface corresponding to the external network or the like, reception of facsimile signal through the facsimile circuit 14 or the like) through each interface, the input is recognized to be a return instruction and the process proceeds to step S210.

In step S210, the micro computer 27 controls the regulators 32a, 32b so as to restart voltage supply from the regulators 32a, 32b to the RAMs 25b, 25c, 25d and the DIMM 29. As a result, power is supplied to each of the RAMs 25b, 25c, 25d and the DIMM 29.

In step S220, the micro computer 27 controls the regulators 32a, 32b so as to restart voltage supply from the regulators 32a, 32b to the memory control ASIC 22 and operate the memory control ASIC 22. It is to be noted that when voltage supply to the buffer 22a in the memory control ASIC 22 has been stopped as described above, voltage supply to the buffer is restarted.

In step S230, the micro computer 27 executes a predetermined initialization processing for each of the RAMs 25b, 25c, 25d and the DIMM 29 so as to make them be in an initialized state.

In step S240, the micro computer 27 cancels the self-refresh state of the RAM 25a.

In step S250, the micro computer 27 divides and writes back the programs recorded in the RAM 25a of which self-refresh state has been canceled into each of the RAMs 25a, 25b, 25c, 25d so as to return each of the RAMs to a state before the step S110. As a result, the return processing to the normal operation mode is completed.

When the electronic device 10 returns to the normal operation mode, power supply to each of the CPU 21, the ROM 26, the print mechanism unit 13, the scanner unit 15, the scanner control ASIC 28, a part of I/O control ASIC 24 to which power supply has been stopped is also restarted in the electronic device 10.

When the transition processing from the normal operation mode to the power saving mode is performed, the programs are stored only in the RAM 25a which receives power supply by the regulators 31a, 31b among the RAMs 25a to 25d in some case. In such case, the processing in the above step S110 in the flowchart in FIG. 4 is not required and the processing in the above step S250 in the flowchart in FIG. 5 is also not required.

According to the embodiment, the electronic device 10 divides the plurality of RAMs 25a, 25b, 25c, 25d into the RAM 25a to which power is supplied by the regulators 31a, 31b and the RAMs 25b, 25c, 25d to which power is supplied by the regulators 32a, 32b as described above. Then, at the time of transition to the power saving mode, programs stored in each of the RAMs 25a, 25b, 25c, 25d are collectively recorded in the RAM 25a. Thereafter, at least the RAM 25a is made to be in the self-refresh state and the regulators 32a, 32b are controlled so as to stop power supply to each of the RAMs 25b, 25c, 25d. In other words, in the power saving mode, power supply to the some of RAMs, which is necessary for holding the programs among the plurality of RAMs is continued and power supply to other RAMs is stopped. This makes it possible to enhance the reduction in power consumption in the power saving mode more.

Further, as described above, program data divided and stored in the RAMs 25a, 25b, 25c, 25d before transition to the power saving mode is recorded in the RAM 25a. Then, the RAM 25a is self-refreshed so that the programs which have been divided and stored in each of the RAMs 25a, 25b, 25c, 25d before transition to the power saving mode can be reliably held in the power saving mode. In addition, since the programs are held in the RAM in the power saving mode, when the electronic device 10 returns from the power saving mode to the normal operation mode, a component (CPU 21 or the like) which executes the programs can read out the programs quickly and execute the programs instantaneously.

A modification of the invention is described. In the modification, only different points from the above embodiment are described.

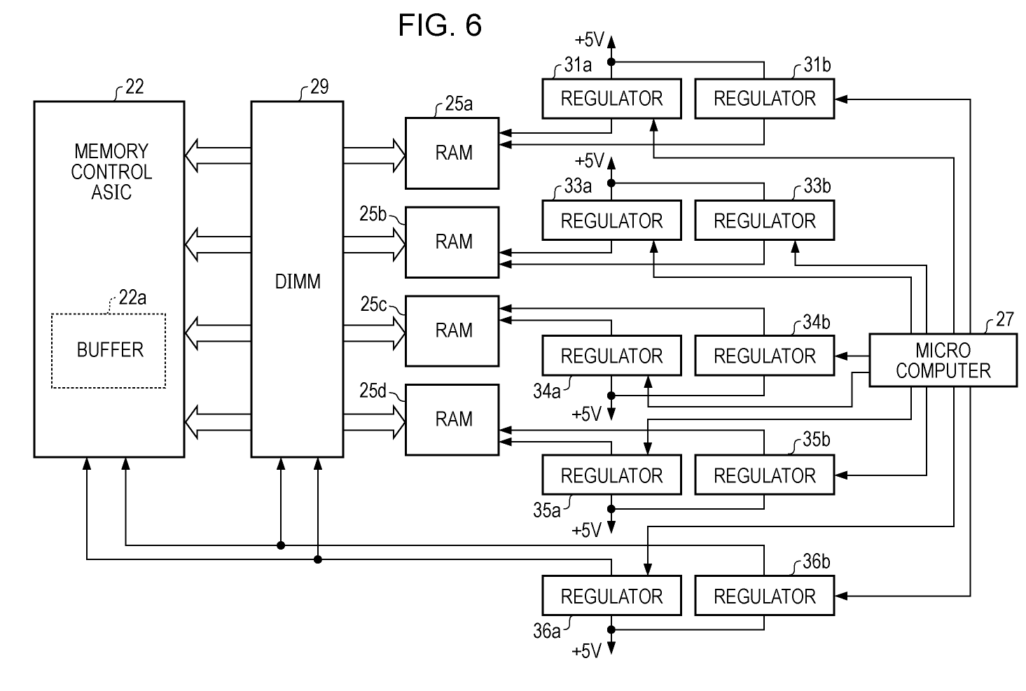

FIG. 6 is a block diagram illustrating a circuit including the memory control ASIC 22, the plurality of RAMs 25a, 25b, 25c, 25d, and the micro computer 27. FIG. 6 illustrates an example different from a configuration in FIG. 3. In FIG. 6, a plurality of regulators which supply power to corresponding RAMs with supply paths different from each other are arranged. The plurality of regulators are a plurality of power supply units (regulators) which correspond to the plurality of RAMs 25a, 25b, 25c, 25d in a one-to-one correspondence. That is to say, regulators 31a, 31b correspond to the RAM 25a, regulators 33a, 33b correspond to the RAM 25b, regulators 34a, 34b correspond to the RAM 25c, and regulators 35a, 35b correspond to the RAM 25d. Further, regulators 36a, 36b are arranged in FIG. 6. The regulator 36a outputs a voltage of 1.8 V as a power supply voltage to the memory control ASIC 22 and the DIMM 29. The regulator 36b outputs a voltage of 0.9 V as a reference voltage to the memory control ASIC 22 and the DIMM 29.

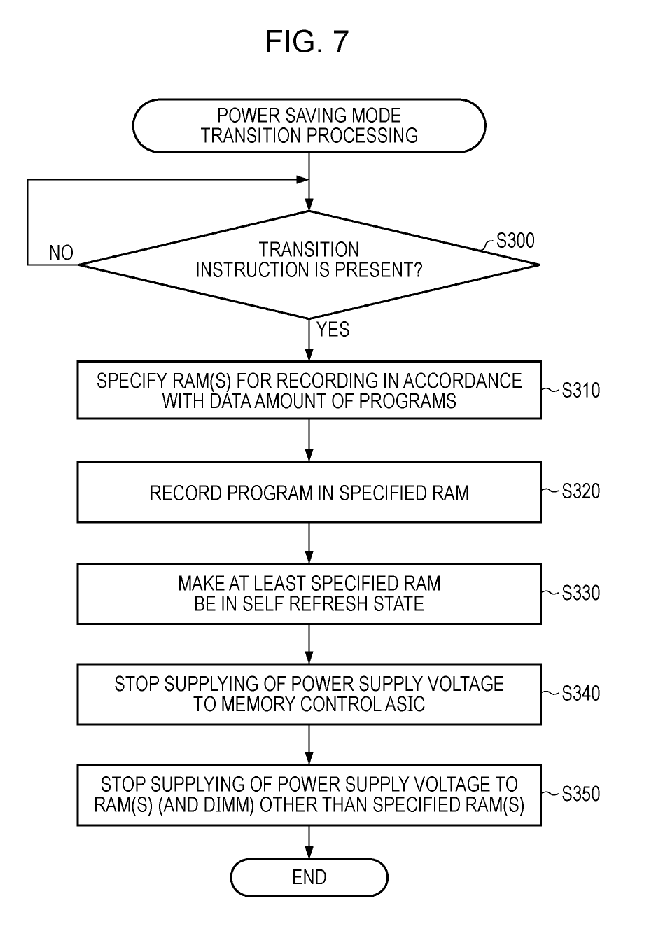

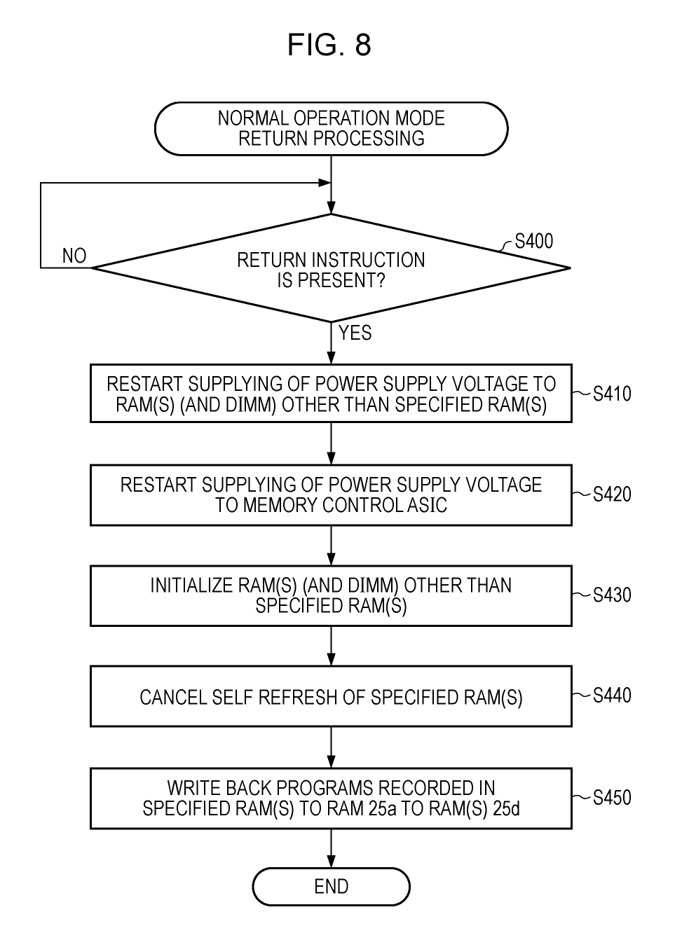

The regulators 31a, 31b, 33a, 33b, 34a, 34b, 35a, 35b, 36a, 36b are connected to the micro computer 27. The regulators 31a, 31b, 33a, 33b, 34a, 34b, 35a, 35b, 36a, 36b turn ON/OFF of supply voltage (power supply voltage and reference voltage) supply to each of the corresponding RAMs 25a, 25b, 25c, 25d, the memory control ASIC 22, and the DIMM 29 based on the control of the micro computer 27. Hereinafter, a transition processing from the normal operation mode to the power saving mode (FIG. 7) and a return processing from the power saving mode to the normal operation mode (FIG. 8) which are performed by the micro computer 27 in the configuration where the regulators are arranged for each of the RAMs as described above are described.

FIG. 7 is a flowchart illustrating the transition processing from the normal operation mode to the power saving mode. A processing in Step S300 is the same as that in the above step S100 (FIG. 4).

The micro computer 27 specifies, in step S310, the necessary number of RAMs (the number of RAMs) for recording all the programs stored in the RAMs 25a, 25b, 25c, 25d based on data amount (total amount) of the programs which are being stored in the RAMs 25a, 25b, 25c, 25d at this time and the capacities of each of the RAMs 25a, 25b, 25c, 25d. In this case, for example, the order of priority when specifying is set to the order of RAMs 25a, 25b, 25c, 25d. If the data amount of the above programs is equal to or less than a capacity of the RAM 25a, only the RAM 25a is specified as a RAM to which the programs are stored. On the other hand, if the data amount of the above programs is more than the capacity of the RAM 25a, the RAMs 25a, 25b are specified. If the data amount of the above programs is more than a total capacity of the RAMs 25a, 25b, RAMs 25a, 25b, 25c are specified. If the data amount of the above programs is more than a total capacity of the RAMs 25a, 25b, 25c, all the RAMs 25a, 25b, 25c, 25d are specified.

In step S320, the micro computer 27 copies programs which are being stored in the RAMs 25a, 25b, 25c, 25d at this time so as to record the copied programs in RAM(s) specified in the above step S310. At this time, when the above specified RAMs are in plural, data of the programs are divided and recorded into the plurality of RAMs.

In step S330, the micro computer 27 makes at least RAM(s) specified in the above step S310 among the plurality of RAMs 25a, 25b, 25c, 25d be in a self-refresh state. As a result, in the above specified RAM(s), the recorded contents at that time (programs which have stored in the RAMs 25a, 25b, 25c, 25d before step S320) are held.

In step S340, the micro computer 27 controls regulators 36a, 36b so as to stop voltage supply from the regulators 36a, 36b to the memory control ASIC 22. Therefore, the memory control ASIC 22 is made to be in an undriven state.

In step S350, the micro computer 27 stops voltage supply by the regulators corresponding to RAM(s) other than the RAM(s) specified in the above step S310 and controls the regulators 36a, 36b so as to stop voltage supply from the regulators 36a, 36b to the DIMM 29. In the modification, it is assumed that the RAMs 25a, 25b are specified in the above step S310. In this case, the micro computer 27 controls the regulators 34a, 34b and the regulator 35a, 35b corresponding to the RAM 25c, RAM 25d, respectively, so as to stop voltage supply from the regulators 34a, 34b and the regulators 35a, 35b to the RAMs 25c and the RAM 25d, respectively.

FIG. 8 is a flowchart illustrating a return processing from the power saving mode to the normal operation mode. A processing in step S400 is the same as that in the above step S200 (FIG. 5).

The micro computer 27 controls the regulators (regulators 34a, 34b, regulators 35a, 35b) corresponding to the RAMs (RAM 25c and RAM 25d) other than the above specified RAMs and the regulators 36a, 36b so as to restart voltage supply to each of the RAMs other than the above specified RAMs and the DIMM 29 in step S410.

In step S420, the micro computer 27 controls the regulators 36a, 36b so as to restart voltage supply from the regulators 36a, 36b to the memory control ASIC 22 and operate the memory control ASIC 22.

In step S430, the micro computer 27 executes a predetermined initialization processing for each of the RAMs (RAM 25c and RAM 25d) other than the specified RAMs and the DIMM 29 so as to make them be in an initialized state.

In step S440, the micro computer 27 cancels the self-refresh state of the above specified RAMs (RAM 25a and RAM 25b).

In step S450, the micro computer 27 divides and writes back the above programs recorded in the RAMs (RAM 25a and RAM 25b) of which the self-refresh state has been canceled into each of the RAMs 25a, 25b, 25c, 25d so as to return the RAMs to a state before the step S320. As a result, the return processing to the normal operation mode is completed.

According to the modification, the electronic device 10 has a configuration in which power is supplied to each of the plurality of RAMs 25a, 25b, 25c, 25d by the regulators different from each other. At the time of transition to the power saving mode, necessary RAM(s) for recording programs stored in the RAMs 25a, 25b, 25c, 25d is(are) specified based on the data amount of the programs. Then, the programs stored in the RAMs 25a, 25b, 25c, 25d are collectively recorded in the specified RAM(s). Thereafter, at least the specified RAM(s) is(are) made to be in the self-refresh state. The regulators which correspond to each of the RAM(s) other than the specified RAM(s) are controlled so as to stop power supply thereto. That is, RAM(s) to which power supply is continued and RAM(s) to which power supply is stopped in the power saving mode can be changed based on the data amount of the programs to be held in the power saving mode. Therefore, program data can be reliably held while realizing reduction in power consumption in the power saving mode.

The entire disclosure of Japanese Patent Application No. 2009-208229, filed Sep. 9, 2009 is expressly incorporated by reference herein.

What is claimed is:

1. An electronic device comprising:
a plurality of RAMs which are capable of executing self-refresh;
a first power supply unit which supplies power to some of RAMs among the above plurality of RAMs;
a second power supply unit which supplies power to RAMs other than the some of RAMs among the above plurality of RAMs with supply paths different from that of the first power supply unit; and
a controller which controls power supply based on change of operation modes,
wherein when the controller receives a transition instruction to a power saving mode, the controller records programs stored in the plurality of RAMs in the some of RAMs, makes at least the some of RAMs be in a self-refresh state, and stops power supply to the RAMs other than the some of RAMs by the second power supply unit, and when the controller receives a return instruction from the power saving mode to a normal operation mode, the controller restarts power supply to the RAMs other than the some of RAMs by the second power supply unit, cancels the self-refresh state of the some of RAMs, and writes back the programs recorded in the some of RAMs into each of the plurality of RAMs.

2. The electronic device according to claim 1,
wherein the programs are programs which are necessary for responding to at least one of a print request from the outside, a request to receive or transmit a facsimile, and a request to control a user interface.

3. The electronic device according to claim 1,
wherein when the controller receives the transition instruction to the power saving mode, the controller records programs stored in the plurality of RAMs in the some of RAMs and makes all of the plurality of RAMs in a self-refresh state.

4. The electronic device according to claim 1,
wherein the electronic device is a printer.

5. The electronic device according to claim 1,
wherein the electronic device is a complex machine including at least a printing function, a scanning function and a facsimile function.

6. An electronic device comprising;
a plurality of RAMs which are capable of executing self-refresh;
a plurality of power supply units which correspond to the plurality of RAMs in a one-to-one correspondence and supply power to the corresponding RAMs with supply paths which are different from each other; and
a controller which controls power supply based on change of operation modes,
wherein when the controller receives a transition instruction to a power saving mode, the controller specifies one or more RAMs which are necessary for recording the programs from the plurality of RAMs based on data amount of the programs stored in the plurality of RAMs, records the programs in the specified RAM(s), makes at least the specified RAM(s) be in a self-refresh state, and stops power supply to the RAM(s) other than the specified RAM(s) by each of the power supply units, and when the controller receives a return instruction from the power saving mode to a normal operation mode, the controller restarts power supply to the RAM(s) other than the specified RAM(s), cancels the self-refresh state of the specified RAM(s), and writes back the programs recorded in the specified RAM(s) into each of the plurality of RAMs.

7. An electronic device comprising;
a plurality of RAMs which are capable of executing self-refresh;
a first power supply unit which supplies power to some of RAMs in which a predetermined program is stored among the above plurality of RAMs;
a second power supply unit which supplies power to RAMs other than the some of RAMs among the above plurality of RAMs with supply paths different from that of the first power supply unit; and
a controller which controls power supply based on change of operation modes,
wherein when the controller receives a transition instruction to a power saving mode, the controller makes at least the some of RAMs be in a self-refresh state, and stops power supply to the RAMs other than the some of RAMs by the second power supply unit, and when the controller receives a return instruction from the power saving mode to a normal operation mode, the controller restarts power supply to the RAMs other than the some of RAMs by the second power supply unit, and cancels the self-refresh state of the some of RAMs.
